(19) United States
(12) Patent Application Publication
(10) Pub. No.: US 2025/0212114 A1
(43) Pub. Date: Jun. 26, 2025

(54) METHOD, DEVICE, AND SYSTEM FOR POWER SAVING IN WIRELESS NETWORKS

(71) Applicant: ZTE CORPORATION, Shenzhen (CN)

(72) Inventors: Xiubin SHA, Shenzhen (CN); Bo DAI, Shenzhen (CN); He HUANG, Shenzhen (CN); Yuan GAO, Shenzhen (CN); Ting LU, Shenzhen (CN); Li NIU, Shenzhen (CN); Jie TAN, Shenzhen (CN)

(21) Appl. No.: 18/850,463

(22) PCT Filed: Apr. 22, 2022
(86) PCT No.: PCT/CN2022/088621

§ 371 Date: Sep. 24, 2024

(51) Int. Cl. H04W 52/02

(52) U.S. Cl. CPC H04W 52/0206

(57) ABSTRACT

This disclosure relates generally to a method, device, and system for saving power consumption of network element in wireless communications. One method performed by a first NE including transmitting a first message to a second NE, the first message comprising power saving information, the power saving information comprises an indication of an update to a power saving status of a cell managed by the first NE, the power saving status of the cell comprising at least one of: a deep sleep mode; a light sleep mode; a normal mode; a cell being barred; a cell not being barred; a cell being deactivated or shutdown; a cell to be shutdown; a Bandwidth Part (BWP) being shutdown or to be shutdown; a restriction to a frequency range; or a slot or a symbol being shutdown or to be shutdown.

### TECHNICAL FIELD

This disclosure is directed generally to wireless communications, and particularly to a method, device, and system for exchanging power saving information in a wireless network.

### BACKGROUND

Energy efficiency is a key performance index in the wireless communication network. Controlling power consumption and reducing energy cost is critical for developing and deploying a wireless communication network. Energy saving technology plays an essential role in achieving this goal. From a User Equipment (UE) perspective, UE battery life has great impact on user experience. From a network perspective, energy consumption is a key factor to consider for improving investment efficiency for operators. It is beneficial to have the capability to dynamically control the power consumption of various network elements and/or UEs yet still meet performance requirement.

### SUMMARY

This disclosure is directed to a method, device, and system for saving power consumption of network element in a wireless network.

In some embodiments, a method performed by a first Network Element (NE) in a wireless network is disclosed. The method may include: transmitting a first message to a second NE, the first message comprising power saving information, the power saving information comprises an indication of an update to a power saving status of a cell managed by the first NE, the power saving status of the cell comprising at least one of: a deep sleep mode; a light sleep mode; a normal mode; a cell being barred; a cell not being barred; a cell being deactivated or shutdown; a cell to be deactivated or shutdown; a Bandwidth Part (BWP) being shutdown or to be shutdown; a restriction to a frequency range; or a slot or a symbol being shutdown or to be shutdown.

In some embodiments, a method performed by a first Network Element (NE) in a wireless network is disclosed. The method may include: transmitting a first message to a second NE, the first message comprising at least one of: a traffic characteristic of a service for a UE served by the second NE; or a UE behavior information of the UE, wherein the UE behavior information comprises at least one of: a UE mobility trajectory; a visited cell record comprising a list of visited cells and a camped time duration associated with each visited cell in the list of visited cells; a UE mobility direction; a UE mobility velocity; a frequency of cell changes for the UE in a predetermined time duration; a geo-stationary indication of the UE; or a type of the UE, the type of the UE comprising at least one of: Internet of things (IoT) UE, Ultra-Reliable Low-Latency Communication (URLLC) UE, enhanced Mobile Broadband (eMBB) UE, or massive Machine Type Communication (mMTC) UE.

In some embodiments, a method performed by a User Equipment (UE) in a wireless network is disclosed. The method may include: receiving a message from an NE in the wireless network, the message comprising beam level access control information for the UE, and the beam level access control information comprising at least one of: a set of beam level Unified Access Control (UAC) parameters associated with a list of beams; or a beam level access control indicator associated with the list of beams.

In some embodiments, there is network element or UE comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1A shows an example wireless communication network.

FIG. 1B shows an example Open Radio Access Network (O-RAN).

FIG. 2 shows an example wireless network node.

FIG. 3 shows an example user equipment.

FIG. 4 shows an exemplary message flow for resource status update, or gNB-DU status indication.

FIG. 5 shows exemplary message flow for configuration update.

FIGS. 6-7 show exemplary message flows for bandwidth (BWP, frequency range) shutdown, reduction, or restriction.

FIGS. 8-10 show exemplary message flows for traffic characteristics or UE behavior information update.

FIG. 11 shows exemplary message flow for cell/carrier shutdown priority and neighbor cell relationship signaling.

FIGS. 12-13 show exemplary message flows for signal transmitting power adjustment, resource activation/deactivation.

FIG. 14 shows exemplary message flow for sending beam level Unified Access Control configuration.

FIG. 15 shows exemplary message flow for sending various cell selection reselection assistance information.

FIG. 16 shows exemplary message flow sending network power saving configuration.

### DETAILED DESCRIPTION

### Wireless Communication Network

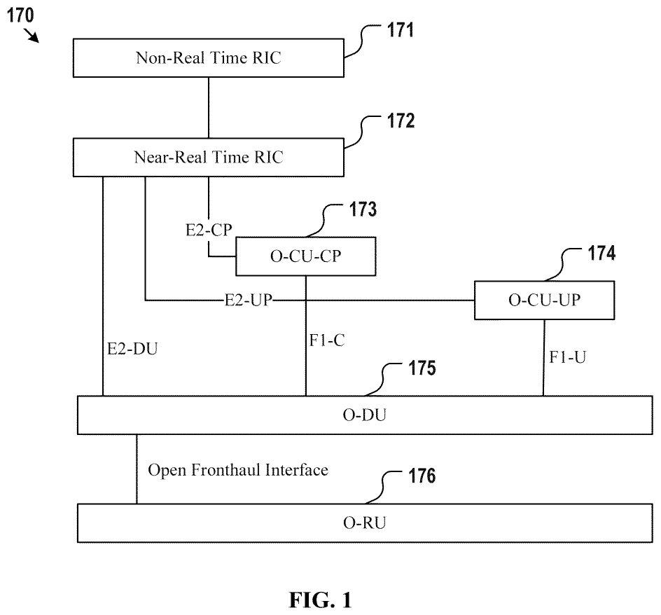

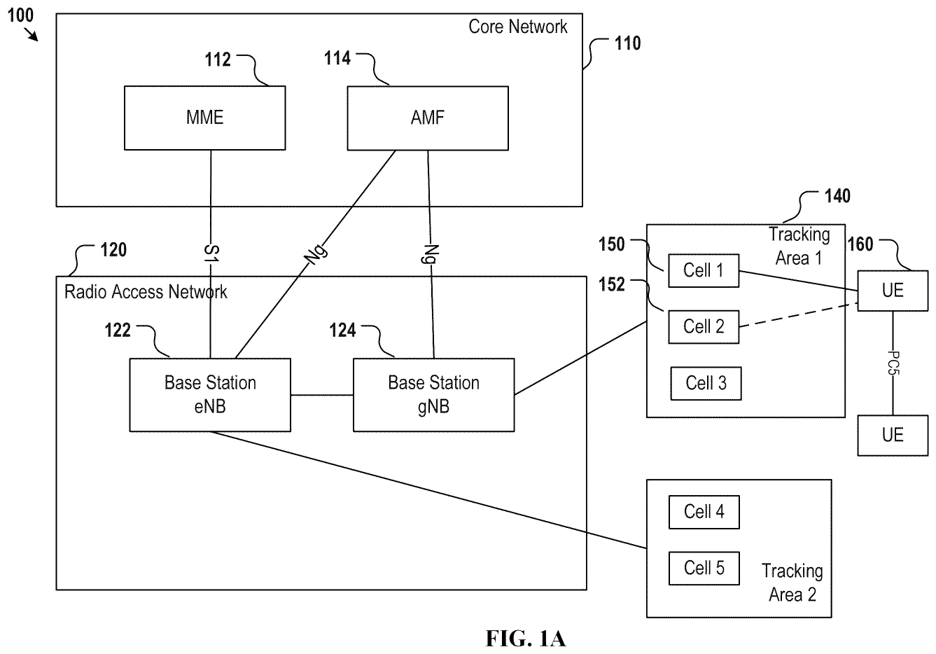

FIG. 1A shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1A. The RAN 120 further includes multiple base stations, for example, base stations 122 and 124. The base stations may include at least one evolved NodeB (eNB) for 4G LTE, or a Next generation NodeB (gNB) for 5G New Radio (NR), or any other type of signal transmitting/receiving device such as a UMTS NodeB. The eNB 122 communicates with the MME 112 via an S1 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1A. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, Internet of Things (IoT) devices, MTC/eMTC devices, distributed remote sensor devices, roadside assistant equipment, XR devices, and desktop computers. The UE 160 may also be generally referred to as a wireless communication device, or a wireless terminal. The UE 160 may support sidelink communication to another UE via a PC5 interface.

In some example implementations, as shown in FIG. 1B, the RAN 120 may be implemented as O-RAN 170. The O-RAN 170 may include a non-real-time RAN Intelligent Controller (non-RT RIC) 171. The non-RT RIC 171 may provide a logical function that enables non-real-time control and optimization of RAN elements and resources, Artificial Intelligence/Machine Learning (AI/ML) workflow including model training and updates, and policy-based guidance of applications/features in near-real-time RAN Intelligent Controller (near-RT RIC) 172. The near-RT RIC 172 may provide a logical function that enables near-real-time control and optimization of O-RAN elements and resources via fine-grained data collection and actions over E2 interface (e.g., E2-DU, E2-CP, and E2-UP). The O-RAN 170 may also include an O-RAN Central Unit (O-CU), which is a logical node hosting RRC, Service Data Adaption Protocol (SDAP) and Packet Data Convergence Protocol (PDCP) protocols. Logically, the O-CU is a combination of O-CU-CP 173 for control plane and O-CU-UP 174 for user plane. The O-RAN 170 may also include an O-RAN Distributed Unit (O-DU) 175, which is a logical node hosting these layers: Radio Link Control (RLC), Medium Access Control (MAC), and High-Physical (High-PHY), based on a lower layer functional split. The O-RAN 170 may further include an O-RAN Radio Unit (O-RU) 176, which is a logical node hosting Low-Physical (Low-PHY) layer and Radio Frequency (RF) processing based on a lower layer functional split.

In an O-RAN deployment, similar information and information exchange procedure between gNB-CU and gNB-DU may be used for information exchange between RIC (e.g., non-RT RIC, or near-RT RIC) and O-CU, between RIC and O-DU, between Operation and Maintenance function/entity (OAM) and DU, or between OAM and CU.

While the description below focuses on cellular wireless communication systems as shown in FIG. 1A, the underlying principles are applicable to other types of wireless communication systems for paging wireless devices. These other wireless systems may include but are not limited to Wi-Fi, Bluetooth, ZigBee, and WiMax networks.

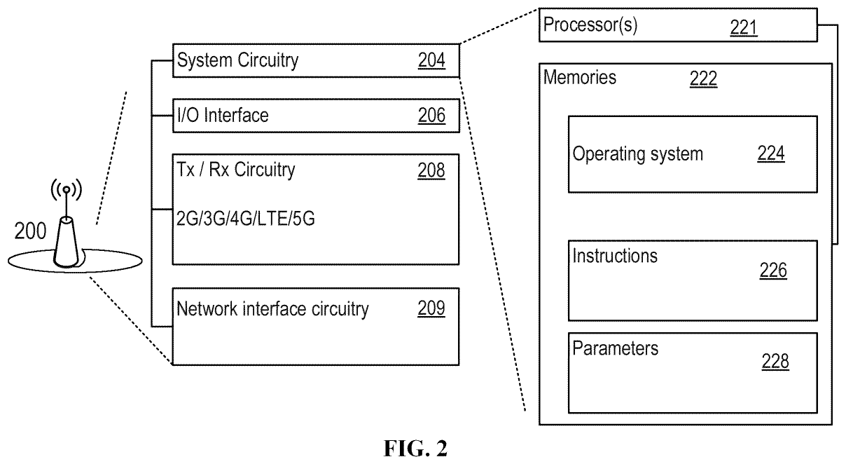

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

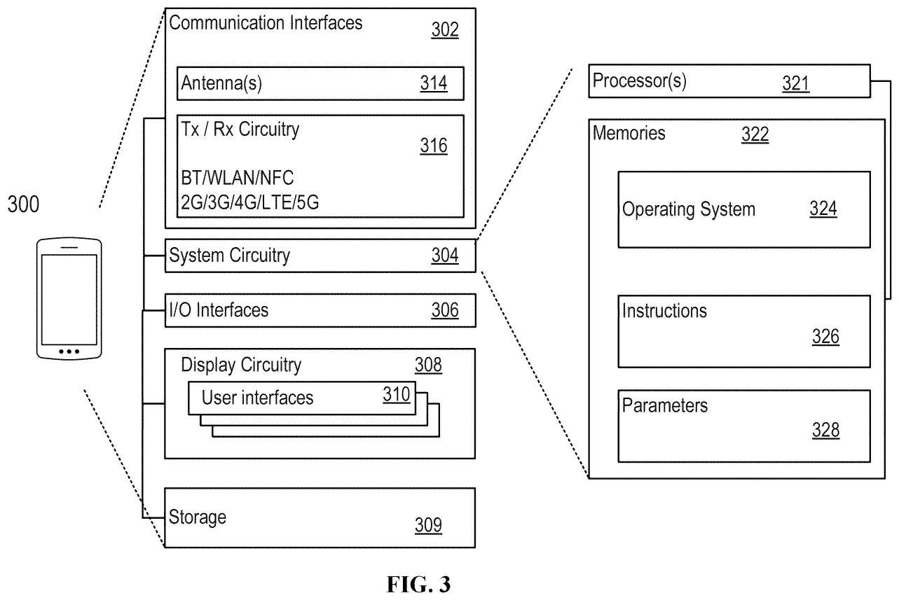

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

### RAN Node Interaction

Energy consumption has become a key part of the operators' operating expenses (OPEX). In wireless networks, significant energy consumption comes from the radio access network and in particular from the hardware circuitries such as Active Antenna Unit (AAU), Radio Unit (RU), Remote Radio Unit (RRU), Power Amplifier (PA), and the like.

In the wireless network, one mechanism for saving network energy consumption is to aggregate (or transfer) partial or all load from one network element to another network element. For example, multiple RAN nodes (e.g., gNBs, eNBs, or ng-eNBs, or a combination thereof) may interact with each other so each node may exchange power saving related information with regard to various resources and statuses. The resources may include: cell, carrier, beam, network slice, Bandwidth Part (BWP), bandwidth represented by a frequency range, slot, or symbol. The statuses may include a power saving mode/state. With power saving information from other network elements, a network element such as a RAN node, may make a more informed choice, for example, when attempting to transfer certain traffic or service to another RAN node, and achieving a higher successful transfer rate while maintaining the service requirement such as a Quality of Service (QOS) requirement. As some load is offloaded, it is possible for the RAN node to dynamically shutdown certain resources and their corresponding hardware circuitry, to save energy. Load transfer may be implemented in various levels corresponding to different granularities. For example, a whole carrier may be shutdown, if the traffic supported by the carrier may be covered by another carrier in another RAN node. For another example, a beam may be shutdown, if another beam may be utilized for offloading the traffic. For another example, an under-used frequency range may be shutdown, to save the operating cost of related hardware. Therefore, it is important for the RAN nodes and other network elements to be able to exchange power saving information with each other. It is also important to implement the resource status exchange that covers different levels, such as cell level, carrier level, beam level, BWP level, slot/symbol level, etc.

In this disclosure, the power saving information may include:
resource status update and status indication;
network element configuration update;
resource shutdown/reduction request or indication;
resource activation/deactivation request or indication;
traffic characteristics and UE behavior information;
neighboring cell relationship;
Tx power adjustment;
access control information.

In this disclosure, not only the resource status information may be exchanged between RAN nodes, it may also be exchanged between gNB-CU and gNB-DU. In an O-RAN deployment, the resource status information may also be exchanged between a RIC and an O-CU or an O-DU.

### Embodiment 1: Resource Status Update

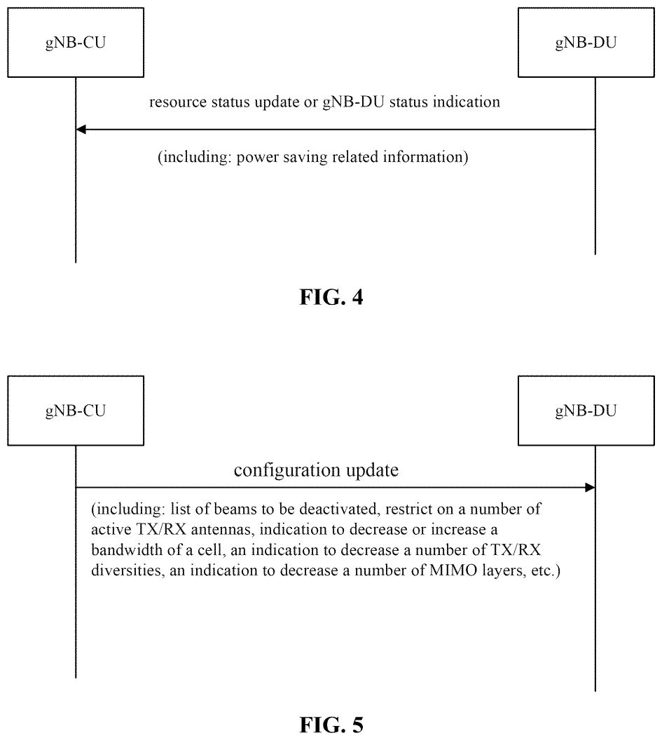

FIG. 4 illustrates an example message flow for sending resource status update, and/or power saving status indication. As an example, the power saving information may be sent from a gNB-DU to a gNB-CU.

The gNB-DU may send a resource status update message, or a gNB-DU status indication to the gNB-CU. The power saving information may include an indication of an update to a power saving status of a cell managed by the gNB-DU, the power saving status of the cell may include at least one of:
a deep sleep mode (or state);
a light sleep mode (or state);
a normal mode (or state);
a cell being barred;
a cell not being barred;
a cell being deactivated or shutdown;
a cell to be shutdown;
a Bandwidth Part (BWP) being shutdown or to be shutdown;
a restriction to a frequency range; or
a slot or a symbol being shutdown or to be shutdown.

In the deep sleep mode, at least one of: radio circuitries, radio resource, or network component is shutdown. For example, an Active Antenna Unit (AAU), a Radio Unit (RU), a Remote Radio Unit (RRU), or a Power Amplifier (PA) may be shutdown in a deep sleep mode.

In the light sleep mode, the gNB-DU transmits or receives radio signal following a larger Discontinuous Reception (DRX) cycle or time interval than in the normal mode. For example, multiple DRX cycles may be configured and one of the DRX cycles may be used in a normal mode. In the light sleep mode, a longer DRX cycles may be selected from the configured DRX cycles.

### Embodiment 2: Configuration Update

FIG. 5 illustrates an example message flow for sending configuration update. As an example, the configuration update may be sent from a gNB-CU to a gNB-DU.

The gNB-CU may send a configuration update message to the gNB-DU. The configuration update message may be used for power saving purpose and may include at least one of:
a beam (or a list of beams) to be deactivated;
an indication to restrict a number of active transmitting (TX) and Receiving (RX) antennas;
an indication to decrease a number of TX/RX diversities;
an indication to decrease a number of MIMO layers;
a configuration with longer periodicity for Synchronization Signal/Physical Broadcast Channel (PBCH) Block (SSB) or Channel State Information Reference Signal (CSI-RS);
multiple SSB/CSI-RS interval configurations, in which the second NE makes dynamic selection;
an indication to decrease or increase a bandwidth of a cell;
an indication to activate or deactivate at least one of: a cell; a carrier; an SSB or a CSI-RS; a slot (or a list of slots); or a symbol (or a list of symbols); or
an indication to switch between two or more power saving modes.

### Embodiment 3: BWP Shutdown Request or Indication

FIG. 6 illustrates an example message flow for sending BWP shutdown request or indication. As an example, the request may be initiated from a gNB-CU to a gNB-DU.

In some scenarios, a certain frequency resource allocated to a RAN node (or a cell) may be under light traffic (or load). This frequency resource may be represented by a Bandwidth Part (BWP), or a frequency range. The traffic may be offloaded or transferred to another BWP or another frequency range. Afterwards, the BWP may be shutdown as there is no more traffic under it; or the frequency range may be either shutdown, or reduced to a small frequency range.

Using BWP as an example, when the gNB-CU decides to shutdown a BWP of a cell, it may switch the service on this particular BWP to other BWP(s) and send a BWP shutdown request or BWP shutdown indication to the gNB-DU to trigger the BWP shutdown operation. The BWP shutdown request or BWP shutdown indication may be sent via the F1AP interface between the gNB-CU and the gNB-DU, via an existing F1AP message, or a newly created F1AP message. An existing Information Item (IE), or a new IE may be used for sending the information.

Under the same principle, the overall cell bandwidth may also be reduced. A frequency range may be reduced, or the selection of the frequency range may be restricted, such that overall active frequency range(s) or Physical Resource Blocks (PRBs) may be aligned and allocated within one cell.

### Embodiment 4: BWP Shutdown Request or Indication

FIG. 7 illustrates another example message flow for sending BWP shutdown request or indication. In this example, the request may be sent from a gNB-DU to a gNB-CU.

As describe in embodiment 3, in some scenarios, a certain frequency resource allocated to a RAN node (or a cell) may be under light traffic (or load). This frequency resource may be represented by a Bandwidth Part (BWP), or a frequency range. The traffic may be offloaded or transferred to another BWP or another frequency range. Afterwards, the BWP may be shutdown as there is no more traffic under it; or the frequency range may be either shutdown, or reduced to a small frequency range.

Using BWP as an example, when the gNB-DU decides to shutdown a BWP of a cell, it may switch the service on this particular BWP to other BWP(s) and send a BWP shutdown request or BWP shutdown indication to the gNB-CU, so the gNB-CU may make corresponding re-configuration. The BWP shutdown request or BWP shutdown indication may be sent via the F1AP interface between the gNB-CU and the gNB-DU, via an existing F1AP message, or a newly created F1AP message. An existing Information Item (IE), or a new IE may be used for sending the information.

Under the same principle, the overall cell bandwidth may also be reduced. A frequency range may be reduced, or the selection of the frequency range may be restricted, such that overall active frequency range(s) or Physical Resource Blocks (PRBs) may be aligned and allocated within one cell.

### Embodiment 5: Traffic Characteristics or UE Behavior Information

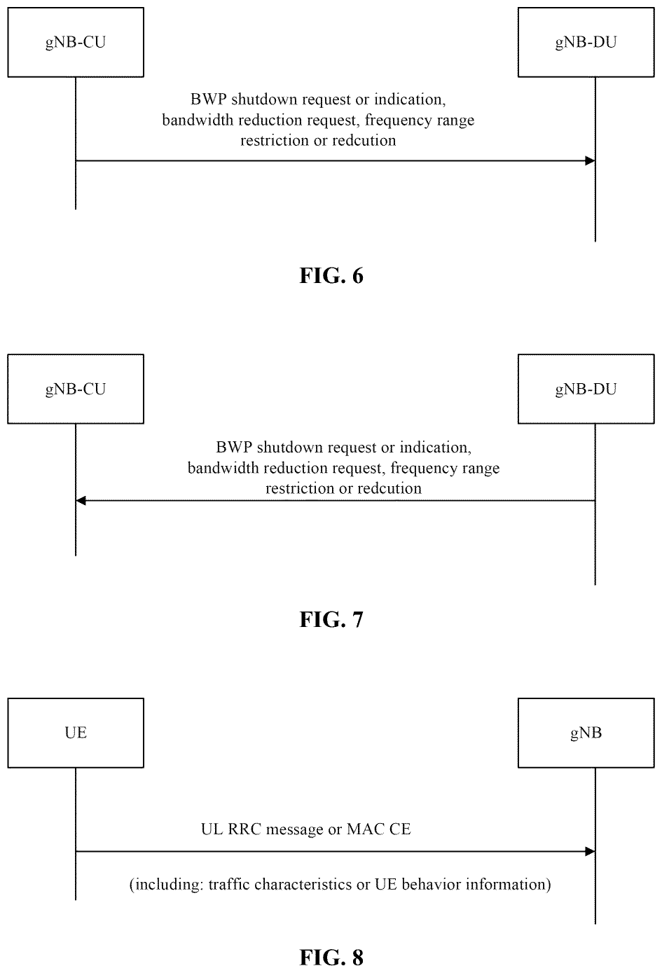

FIG. 8 illustrates an example message flow for sending traffic characteristics or UE behavior information. In this example, the message may be sent from a UE to a gNB, via an uplink (UL) RRC message, or a MAC Control Element (CE) message. The UL RRC message may include at least one of: a UEAssistanceInformation message, an RRCReconfigurationComplete message, an RRCResumeComplete message, an RRCSetupComplete message, an RRCReestablishmentComplete message, or an UEInformationResponse message.

The traffic characteristics may include at least one of:
a delay of the service is above a predetermined threshold;
a preference for a larger User Perceived Throughput (UPT) than a current UPT;
a predicted or estimated arrival time of a Data Radio Bearer (DRB) or a Logical Channel (LC) associated with the service for the UE;
an arrival spread time of the DRB or the LC;
a periodicity of packet arrival for packets associated with the service;
a maximum delay or spread time for data transmission associated with the service for the UE;
a total traffic volume of the service for the UE; or
a preferred Guaranteed Bit Rate (GBR) of the service for the UE.

The UE behavior information may include at least one of:
a UE mobility trajectory;
a visited cell record comprising a list of visited cells and a camped time duration associated with each visited cell in the list of visited cells;
a UE mobility direction;
a UE mobility velocity (e.g., kilometer/hour);
a frequency of cell changes for the UE in a predetermined time duration;
a geo-stationary indication of the UE; or
a type of the UE, the type of the UE comprising one of: Internet of things (IoT) UE, Ultra-Reliable Low-Latency Communication (URLLC) UE, enhanced Mobile Broadband (eMBB) UE, or massive Machine Type Communication (mMTC) UE.

Alternatively, the traffic characteristics or UE behavior information may be sent:
From one RAN node to another RAN node. The RAN node includes at least one of: a gNB, an eNodeB (eNB), or an ng-eNodeB (ng-eNB).
From a gNB-CU to a gNB-DU; or
In an O-RAN deployment, from a RIC to an O-CU, or an O-DU.

### Embodiment 6: Traffic Characteristics or UE Behavior Information

FIG. 9 illustrates another example message flow for sending traffic characteristics or UE behavior information. In this example, the message may be sent from a UE to a core network (or a core network node), via a Non-Access Stratum (NAS) message. The NAS message may include at least one of: a Tracking Area Update Request, an Attach Request, or a Register Request.

The traffic characteristics may include at least one of:
an arrival time of the service for the UE;
an arrival spread time of the service for the UE;
a periodicity of packet arrival for packets associated with the service;
a maximum aggregated data rate associated with the service for the UE; or.
a preferred GBR of the service for the UE.

The UE behavior information may be referred to the description in embodiment 5.

### Embodiment 7: Traffic Characteristics or UE Behavior Information

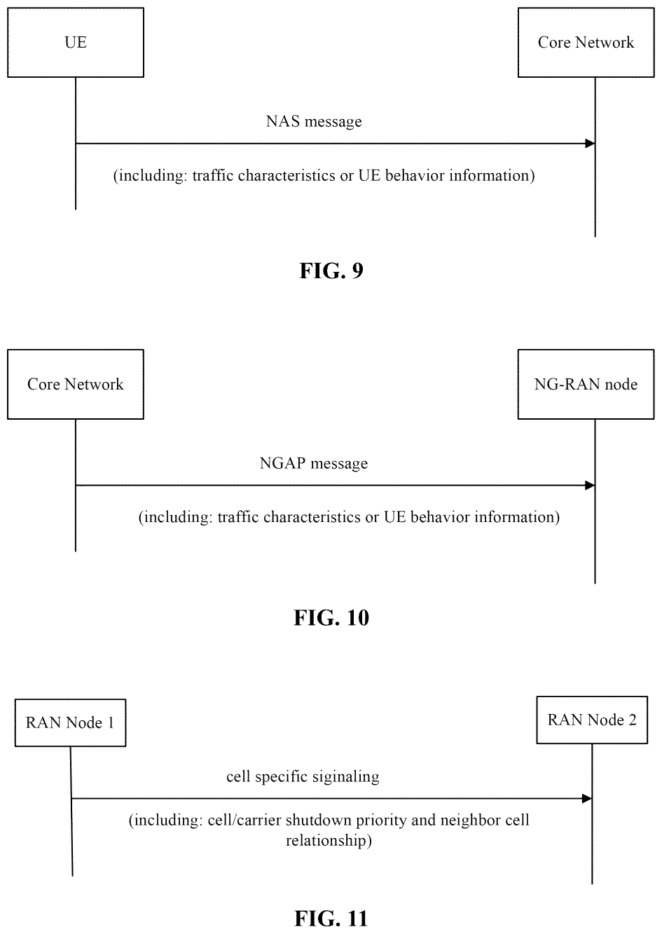

FIG. 10 illustrates another example message flow for sending traffic characteristics or UE behavior information. In this example, the message may be sent from a core network to a RAN node, via a UE associated NG Application Protocol (NGAP) message.

The UE associated NGAP message may include at least one of: an INITIAL CONTEXT SETUP REQUEST message, a UE CONTEXT MODIFICATION REQUEST message, a CONNECTION ESTABLISHMENT INDICATION message, a UE INFORMATION TRANSFER message, a UE CONTEXT RESUME RESPONSE message, a HANDOVER REQUEST message, or a PATH SWITCH REQUEST ACKNOWLEDGE message.

The traffic characteristics may include at least one of:
a delay of the service is above a predetermined threshold;
a preference for a larger User Perceived Throughput (UPT) than a current UPT;
an arrival time of a DRB or an LC associated with the service for the UE;
an arrival spread time of the DRB or the LC;
a periodicity of packet arrival for packets associated with the service;
a maximum delay or spread time for data transmission associated with the service for the UE;
a maximum aggregated data rate associated with the service for the UE;
a predicted Downlink (DL) traffic volume and last duration associated with the service for the UE;
a predicted traffic volume and last duration for a cell associated with the UE; or
a number of geo-stationary UEs in the cell.

The UE behavior information may be referred to the description in embodiment 5.

Alternatively, the traffic characteristics or UE behavior information may be sent:
From one RAN node to another RAN node. The RAN node includes at least one of: a gNB, an eNB, or an ng-eNB;
From a gNB-CU to a gNB-DU; or
In an O-RAN deployment, from a RIC to an O-CU, or an O-DU.

### Embodiment 8: Cell/Carrier Shutdown Priority and Neighbor Cell Relationship

FIG. 11 illustrates an example message flow for sending cell/carrier shutdown priority and neighbor cell relationship. In this example, the message may be sent from one RAN node to another RAN node, via a cell specific message.

The message may include a shutdown priority for at least one of: a list of beams managed by RAN node 1, a list of BWPs managed by RAN node 1, a list of slots managed by the RAN node 1, a list of symbols managed by RAN node 1, a list of carriers managed by RAN node 1, or a list of cells managed by the RAN node 1.

In one implementation, the beam, the carrier, the BWP, the slot, or the symbol may be in a scope of a cell.

The message may further include a neighboring cell relationship for at least a pair of neighboring cells. The neighboring cell relationship may include at least one of:
two cells in the pair of neighboring cells having same coverage;
one cell in the pair of neighboring cells acting as a serving cell covers another cell in the pair of neighboring cells; or
one cell in the pair of neighboring cells acting as a serving cell is covered by another cell in the pair of neighboring cells.

Once the neighboring cell relationship is sent to RAN node 2, the RAN node 2 may determine which level the power saving should be applied to. For example, the RAN node 2 may determine to perform a cell shutdown, a carrier shutdown, a beam shutdown, a BWP shutdown, a slot shutdown, or a symbol shutdown, based on the neighboring cell relationship.

Similarly, the cell/carrier shutdown priority and neighbor cell relationship may be exchanged between:
a gNB-CU and a gNB-DU;
in an O-RAN deployment, a RIC and an O-CU or an O-DU.

### Embodiment 9: SSB/CSI-RS TX Power Adjustment

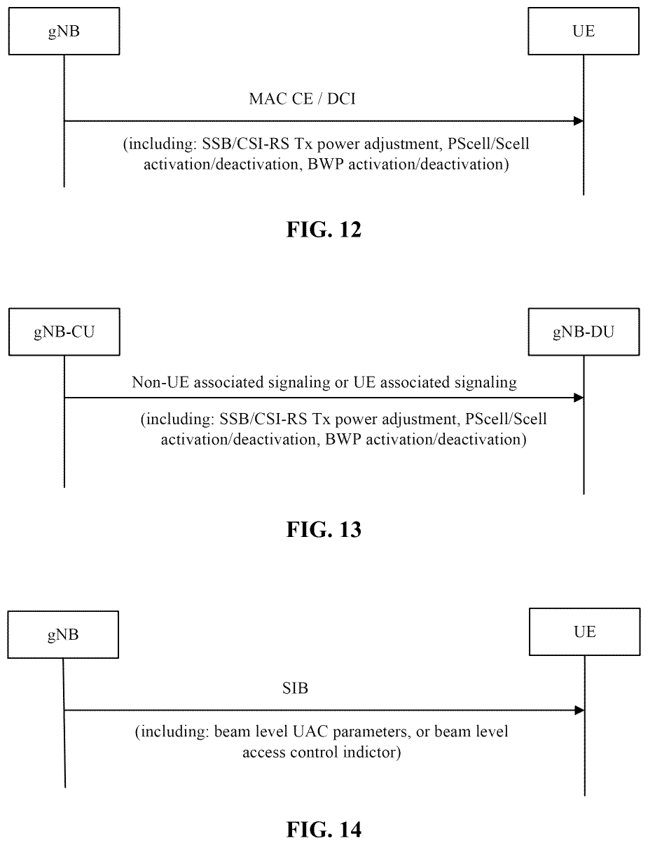

FIG. 12 illustrates an example message flow for sending power saving related information. The message may be sent from a RAN node such as gNB to a UE, via at least one of: a MAC CE message, or a Downlink Control Information (DCI) message.

The power saving related information may include at least one of:
an adjustment to a Synchronization Signal/Physical Broadcast Channel (PBCH) Block (SSB) transmitting (Tx) power;
an adjustment to a Channel State Information Reference Signal (CSI-RS) Tx power;
an indication for an activation or deactivation of a Primary Secondary cell group cell (PScell);
an indication for an activation or deactivation of a Secondary cell (Scell);
an indication for an activation or deactivation of a BWP;
an indication for a restriction on a number of active Transmitting/Receiving (TX/RX) antennas;
an indication for a decrease of a number of active TX/RX diversities;
an indication for a decrease of a number of Multiple Input Multiple Output (MIMO) layers;
a longer periodicity for SSB or CSI-RS;
multiple SSB or CSI-RS interval configurations;
an indication for a decrease or an increase to a cell bandwidth;
an indication for an activation or deactivation of a carrier;
an indication for an activation or deactivation of an SSB or a CSI-RS;
an indication for an activation or deactivation of a slot; or
an indication for an activation or deactivation of a symbol.

In one implementation, adjustment to the SSB Tx power may include at least one of: a target Tx power of the SSB; or an offset between a current SSB Tx power and a target SSB Tx power (a target power is the power after adjustment).

In one implementation, the adjustment to the CSI-RS Tx power includes an offset between a target CSI-RS Tx power and a current SSB Tx power.

In one implementation, when applicable, the operations on, or references to, an SSB, may be replaced with an Synchronization Signal (SS).

Once a resource, such as PScell, Scell, or BWP is deactivated, the UE does not monitor and use the resource until it is activated.

After the gNB adjusts the SSB Tx power or the CSI-RS Tx power, the Tx power used by the gNB for dedicated downlink (DL) channel is not impacted by the adjustment. The dedicated DL channel may include at least one of a Physical Downlink Control Channel (PDCCH) or a Physical Downlink Shared Channel (PDSCH). The gNB will transmit SSB and/or CSI-RS using the corresponding adjusted Tx power.

### Embodiment 10: SSB/CSI-RS TX Power Adjustment

FIG. 13 illustrates another example message flow for sending power saving related information between a gNB-CU and a gNB-DU.

Both the gNB-CU and the gNB-DU may initiate the message.

When the gNB-CU determines the power saving information, it may send the power saving information to the gNB-DU via a UE associated signaling, or a non-UE associated signaling.

The UE associated signaling may include at least one of: a UE CONTEXT MODIFICATION REQUEST message, or a DL RRC MESSAGE TRANSFER message.

The non-UE associated signaling may include at least one of: a GNB-CU CONFIGURATION UPDATE message, or a GNB-DU RESOURCE COORDINATION REQUEST message. The non-UE associated signaling may also include a newly created message.

When the gNB-DU determines the power saving information, it may send the power saving information to the gNB-CU via a UE associated signaling, or a non-UE associated signaling.

The UE associated signaling may include at least one of: a UE CONTEXT MODIFICATION REQUIRED message, or a UL RRC MESSAGE TRANSFER message.

The non-UE associated signaling may include at least one of: a GNB-DU CONFIGURATION UPDATE message, RESOURCE STATUS UPDATE message, or a GNB-DU STATUS INDICATION message.

The power saving related information may be referred to embodiment 9 as described above.

### Embodiment 11: Beam Level Access Control

In a wireless network, to determine whether to allow a UE for a specific service, a Unified Access Control (UAC) is provide. For example, a UAC policy may exist in a cell level. Based on a cell level UAC, a determination may be made for allowing cell access to a UE. In this disclosure, an access control mechanism in a beam level is disclosed, to achieve finer granularity on access control.

Referring to FIG. 14, the base station may send beam level UAC parameters (e.g. UAC parameters per SSB), or beam level access control indicator (e.g. beamUACBitmap, or beamBarredBitmap) to UE via System Information Block (SIB). The UAC parameters and/or the beam level access control indicator may be used to restrict the UE to access a particular beam.

In one implementation, upon receiving the beam level UAC parameters, if the UE supports Beam level UAC, it will use the beam level UAC parameters for access control and ignore the cell level UAC parameters. That is, the beam level UAC parameters overrides the cell level level UAC parameters.

In one implementation, the beam level access control indicator may include a bitmap which indicates whether a particular beam is barred for the UE. Upon receiving the beam level access control indicator, if the UE supports beam level access control, one of the following options may be chosen:

### Option 1

The cell level UAC is only applicable to the beam that is barred (e.g., as indicated by a corresponding bit in beamBarredBitmap).

### Option 2

The cell level UAC is only applicable to the beam that is not barred. If a beam associated with the UE is barred, then for a cell associated with the barred beam, the UE may treat the cell as being barred.

### Embodiment 12: Reducing Cell Selection and/or Reselection Priority for a Cell or a Beam to be Shutdown

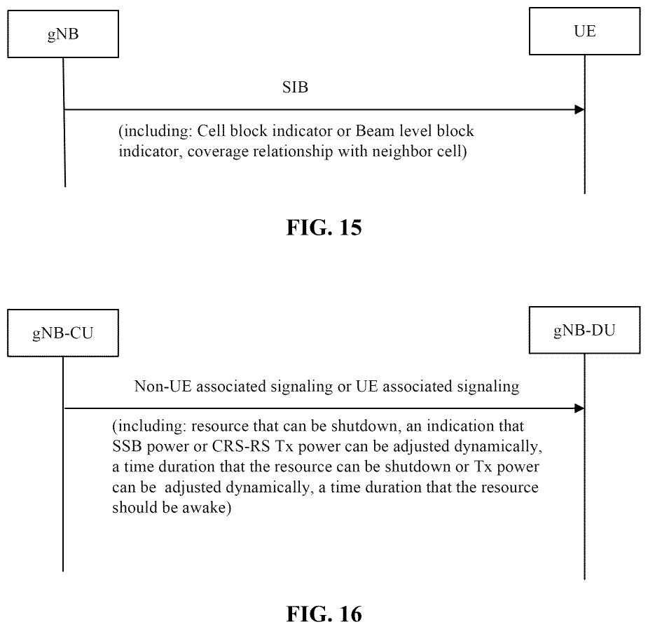

FIG. 15 illustrates an example for reducing cell selection and/or reselection priority for a cell or beam to be shutdown.

When gNB decides to shutdown a cell or beam of a cell for power saving purpose, it may send an indicator (e.g., cell block indicator or beam level block indicator) to UE by SIB, informing the UE to avoid selecting the cell or beam as indicated by the indicator during cell selection or reselection procedure.

Upon receiving the indicator, the UE may reduce the priority of the cell or beam during cell reselection evaluation process by one of the following options:

### Option 1

UE considers the indicated cell or beam to be lowest priority during cell selection and reselection procedure. For example, if there is any other cell or beam available which satisfies the Quality of Service (QOS) requirement (e.g. the cell selection criterion S is fulfilled), the UE shall not select the indicated cell or the indicated beam.

### Option 2

Decreasing an offset value for the measured RSRP of the indicated cell or beam during cell reselection evaluation process. For example, for the indicated cell or beam, the RSRP is set to the measured RSRP-Offsetdepriorizing when perform the cell-ranking criterion decision during cell reselection evaluation process. The Offsetdepriorizing is a pre-defined offset value or an offset value indicated by eNB for adjusting the cell selection preference.

The gNB may also provide a neighbor cell information for a cell to the UE, which at least indicates a neighbor cell which is able to provide same or better coverage, or same or better QoS than the cell.

Upon reception of the neighbor cell information, when the cell or a beam of the cell is barred, the UE may reselect the neighbor cell directly based on the neighbor cell information, or the UE may reselect the neighbor cell with highest priority.

### Embodiment 13: Network Power Saving Configuration for gNB-DU

FIG. 16 illustrates an example providing network power saving configuration or network power saving assistance information for gNB-DU.

For gNB-DU to determine or select a power saving mechanism, gNB-CU or OAM may provide the power saving related information or network power saving assistance information to gNB-DU.

The power saving related information may include at least one of the following:
A resource type for resource(s) that can be shutdown, based on which, gNB-DU can select the resource to be shutdown.
A time period that a resource may be shutdown: the gNB-DU only makes resource shutdown decision in this time period.
A time period that a resource should be awake (or active, activated): the gNB-DU will not attempt to make resource shutdown decision in this time period. If the resource is shutdown in this period, the gNB-DU may wakeup the resource, as the resource is supposed to be awake.
An indication that SSB Tx power or CSI-RS Tx power may be adjusted dynamically, based on which, gNB-DU can decide whether it is allowed to adjust the SSB Tx power or CSI-RS Tx power dynamically.
A time period that Tx power (for SSB or CSI-RS) may be adjusted dynamically. Based on which, gNB-DU may decide when to perform the SSB Tx power or CSI-RS Tx power adjustment dynamically.

The resource type may include as least one of the: gNB-DU, cell, carrier of a cell, beam, slot, or symbol.

The UE associated signaling may include at least one of: a UE CONTEXT SETUP REQUEST message, a UE CONTEXT MODIFICATION REQUEST message, or a DL RRC MESSAGE TRANSFER message.

The non-UE associated signaling may include at least one of: a F1 SETUP RESPONSE message, a GNB-CU CONFIGURATION UPDATE message, or a GNB-DU RESOURCE COORDINATION REQUEST message.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

What is claimed is:

1. A method for wireless communication, performed by a first Network Element (NE) in a wireless network, the method comprising:
transmitting a first message to a second NE, the first message comprising power saving information;
wherein the power saving information comprises an indication for an activation of an SSB.

2. The method of claim 1, wherein:
the first NE comprises a gNodeB Distributed Unit (gNB-DU), and the second NE comprises a gNodeB Central Unit (gNB-CU); and
the power saving information comprises an indication of an update to a power saving status of a cell managed by the first NE, the power saving status of the cell comprising at least one of:
a deep sleep mode;
a light sleep mode;
a normal mode;
a cell being barred;
a cell not being barred;
a cell being deactivated or shutdown;
a cell to be shutdown;
a Bandwidth Part (BWP) being shutdown or to be shutdown;
a restriction to a frequency range; or
a slot or a symbol being shutdown or to be shutdown.

3. The method of claim 2, wherein:
in the deep sleep mode, at least one of: radio circuitries of the first NE, radio resources of the first NE, or network components of the first NE is shutdown; and
in the light sleep mode, the first NE transmits or receives radio signal following a larger Discontinuous Reception (DRX) cycle or time interval than in the normal mode.

4. The method of claim 1, wherein:
the first NE comprises a gNB-CU, and the second NE comprises a gNB-DU; and
the power saving information further comprises at least one of:
a beam to be deactivated;
an indication to restrict a number of active transmitting (TX) and Receiving (RX) antennas;
an indication to decrease a number of TX/RX diversities;
an indication to decrease a number of MIMO layers;
a configuration with longer periodicity for Synchronization Signal/Physical Broadcast Channel (PBCH) Block (SSB) or Channel State Information Reference Signal (CSI-RS);
multiple SSB/CSI-RS interval configurations, in which the second NE makes dynamic selection;
an indication to decrease or increase a bandwidth of a cell;
an indication to activate or deactivate at least one of:
a cell;
a carrier;
a CSI-RS;
a slot; or
a symbol;
an indication to deactivate an SSB; or
an indication to switch between two or more power saving modes.

5. The method of claim 4, wherein the two or more power saving modes comprises at least two of:
a normal mode;
a deep sleep mode, in which at least one of: radio circuitries, radio resources, or network components is shutdown; or
a light sleep mode, in which the second NE transmits or receives radio signal by following a larger DRX cycle or time interval than in normal mode.

6-9. (canceled)

10. The method of claim 1, wherein:
a combination of the first NE and the second NE comprises:
the first NE comprising one of: a gNB, an eNB, or an ng-eNB, and the second NE comprising a UE;
the first NE comprising a gNB-CU, and the second NE comprising a gNB-DU; or
the first NE comprising a RIC in an O-RAN, and the second NE comprising one of: an O-CU, or an O-DU; and
the power saving information comprises at least one of:
an adjustment to an SSB transmitting (Tx) power;
an adjustment to a Channel State Information Reference Signal (CSI-RS) Tx power;
an indication for an activation or deactivation of a Primary Secondary cell group cell (PScell);
an indication for an activation or deactivation of a Secondary cell (Scell);
an indication for an activation or deactivation of a BWP;
an indication for a restriction on a number of active Transmitting/Receiving (TX/RX) antennas;
an indication for a decrease of a number of active TX/RX diversities;
an indication for a decrease of a number of Multiple Input Multiple Output (MIMO) layers;
a longer periodicity for SSB or CSI-RS;
multiple SSB or CSI-RS interval configurations;
an indication for a decrease or an increase to a cell bandwidth;
an indication for an activation or deactivation of a carrier;
an indication for an activation or deactivation of a CSI-RS;
an indication for a deactivation of an SSB;
an indication for an activation or deactivation of a slot; or
an indication for an activation or deactivation of a symbol.

11. The method of claim 10, wherein the adjustment to the SSB Tx power comprises at least one of:
a target Tx power of the SSB; or
an offset between a current SSB Tx power and a target SSB Tx power;
the adjustment to the CSI-RS Tx power comprises an offset between a target CSI-RS Tx power and the SSB Tx power.

12. (canceled)

13. The method of claim 10, wherein the power saving information comprises the adjustment to the SSB Tx power;
after transmitting the first message to the second NE, the method further comprises:
transmitting a dedicated downlink channel using a Tx power not impacted by the adjustment to the SSB Tx power, the dedicated downlink channel comprising at least one of a Physical Downlink Control Channel (PDCCH) or a Physical Downlink Shared Channel (PDSCH); and
transmitting an SSB using an adjusted SSB Tx power by applying the adjustment to the SSB Tx power.

14. The method of claim 10, wherein the power saving information comprises the adjustment to the CSI-RS Tx power;
after transmitting the first message to the second NE, the method further comprises:
transmitting a dedicated downlink channel using a Tx power not impacted by the adjustment to the CSI-RS Tx power, the dedicated downlink channel comprising at least one of a PDCCH or a PDSCH; and
transmitting an CSI-RS using an adjusted CSI-RS Tx power by applying the adjustment to the CSI-RS Tx power.

15. The method of claim 1, wherein:
in response to the first NE comprising the gNB-CU, and the second NE comprising the gNB-DU, the first message comprises at least one of:
a UE associated signaling comprising at least one of: a UE context modification request, or a downlink Radio Resource Control (RRC) message via transfer; or
a non-UE associated signaling comprising at least one of: a gNB-CU configuration update message, or a GNB-DU RESOURCE COORDINATION REQUEST message; and
in response to the first NE comprising the gNB-DU, and the second NE comprising the gNB-CU, the first message comprises at least one of:
a UE associated signaling comprising at least one of: a UE context modification required message, or an uplink RRC message via transfer; or
a non-UE associated signaling comprising at least one of: a gNB-DU configuration update message, a resource status update message, or a gNB-DU status indication message.

16-17. (canceled)

18. A method for wireless communication, performed by a first Network Element (NE) in a wireless network, the method comprising:
transmitting a first message to a second NE, the first message comprising at least one of:
a traffic characteristic of a service for a UE served by the second NE; or
a UE behavior information of the UE, wherein the UE behavior information comprises at least one of:
a UE mobility trajectory;
a visited cell record comprising a list of visited cells and a camped time
duration associated with each visited cell in the list of visited cells;
a UE mobility direction;
a UE mobility velocity;
a frequency of cell changes for the UE in a predetermined time duration;
a geo-stationary indication of the UE; or
a type of the UE, the type of the UE comprising one of: Internet of things (IoT) UE, Ultra-Reliable Low-Latency Communication (URLLC) UE, enhanced Mobile Broadband (eMBB) UE, or massive Machine Type Communication (mMTC) UE.

19. The method of claim 18, wherein:
a combination of the first NE and the second NE comprises:
the first NE comprising one of: a UE, a gNB, an eNodeB (eNB), or an ng-eNodeB (ng-eNB), and the second NE comprising one of: a gNB, an eNB, or an ng-eNB;
the first NE comprising a gNB Central Unit (gNB-CU), and the second NE comprising a gNB Distributed Unit (gNB-DU); or
the first NE comprising a RIC in an O-RAN, and the second NE comprising one of: an O-CU, or an O-DU; and
the traffic characteristic of the UE comprises at least one of:
a delay of the service is above a predetermined threshold;
a preference for a larger User Perceived Throughput (UPT) than a current UPT;
a predicted arrival time of a Data Radio Bearer (DRB) or a Logical Channel (LC) associated with the service for the UE;
an arrival spread time of the DRB or the LC;
a periodicity of packet arrival for packets associated with the service;
a maximum delay or spread time for data transmission associated with the service for the UE;
a total traffic volume of the service for the UE; or
a preferred Guaranteed Bit Rate (GBR) of the service for the UE.

20. The method of claim 18, wherein:
the first NE comprises a UE, and the second NE comprises a core network node; and
the traffic characteristic of the UE comprises at least one of:
an arrival time of the service for the UE;
an arrival spread time of the service for the UE;
a periodicity of packet arrival for packets associated with the service;
a maximum aggregated data rate associated with the service for the UE; or
a preferred GBR of the service for the UE.

21. The method of claim 18, wherein:
a combination of the first NE and the second NE comprises:
the first NE comprises a core network node, and the second NE comprises one of: a gNB, an eNB, an ng-eNB;
the first NE comprising one of: a gNB, an eNB, or an ng-eNB, and the second NE comprising one of: a gNB, an eNB, or an ng-eNB;
the first NE comprising a gNB-CU, and the second NE comprising a gNB-DU; or
the first NE comprising a RIC in an O-RAN, and the second NE comprising one of: an O-CU, or an O-DU; and
the traffic characteristic of the UE comprises at least one of:
a delay of the service is above a predetermined threshold;
a preference for a larger User Perceived Throughput (UPT) than a current UPT;
an arrival time of a DRB or an LC associated with the service for the UE;
an arrival spread time of the DRB or the LC;
a periodicity of packet arrival for packets associated with the service;
a maximum delay or spread time for data transmission associated with the service for the UE;
a maximum aggregated data rate associated with the service for the UE;
a predicted Downlink (DL) traffic volume and last duration associated with the service for the UE;
a predicted traffic volume and last duration for a cell associated with the UE; or
a number of geo-stationary UEs in the cell.

22. A method for wireless communication, performed by a User Equipment (UE) in a wireless network, the method comprising:
receiving a message from an NE in the wireless network, the message comprising beam level access control information for the UE, and the beam level access control information comprising at least one of:
a set of beam level Unified Access Control (UAC) parameters associated with a list of beams; or
a beam level access control indicator associated with the list of beams.

23. The method of claim 22, wherein the message comprises a System Information Block (SIB), and wherein the NE comprises one of a gNB, an eNB, or an ng-eNB.

24. The method of claim 22, wherein, in response to the UE is capable of supporting an access control in a beam level, applying the beam level access control information to a beam in the list of beams, and ignoring a cell level access control configuration for the beam in the list of beams.

25. The method of claim 22, wherein:
the beam level access control indicator comprises a bitmap, the bitmap indicating an access control condition for each beam in the list of beams, the access control condition comprising one of barred or allowed; and
in response to the UE is capable of supporting an access control in a beam level, determining whether a beam in the list of beams is barred or not;
wherein the method further comprising:
applying a UAC policy to the beam only in determination that the beam is barred; and
applying a UAC policy to the beam only in determination that the beam is not barred; and
treating a cell associated with the beam as barred in determination that the beam is barred.

26-27. (canceled)

28. A device for wireless communication comprising a memory for storing computer instructions and a processor in communication with the memory, wherein, when the processor executes the computer instructions, the processor is configured to implement a method in claim 1.

29. A non-transitory computer program product comprising a non-transitory computer-readable program medium with computer code stored thereupon, the computer code, when executed by one or more processors, causing the one or more processors to implement a method of claim 1.
